(19) United States
(12) Patent Application Publication
(10) Pub. No.: US 2026/0171830 A1
(43) Pub. Date: Jun. 18, 2026

(54) DISCHARGE MANAGEMENT METHOD AND SYSTEM

(71) Applicant: RITWIN CORPORATION, Hsinchu County (TW)

(72) Inventors: Tung-Yuan LIAO, Hsinchu County (TW); Chang-Chieh YU, Toayuan City (TW); Ting-Chun HU, Taoyuan City (TW); Yen Yu YAO, Hsinchu County (TW); Chung-Lung LEE, Hsinchu County (TW)

(73) Assignee: RITWIN CORPORATION, Hsinchu County (TW)

(21) Appl. No.: 18/986,449

(22) Filed: Dec. 18, 2024

(51) Int. Cl. H02J 7/00

(52) U.S. Cl. CPC H02J 7/933; H02J 7/50; H02J 7/82; H02J 7/84

(57) ABSTRACT

A discharge management method, applicable for a plurality of standby batteries, comprises: detecting the health status and capacity status of each of standby batteries, treating each of standby batteries as a target battery and performing: determining the relationship between the capacity status of the target battery and a preset capacity threshold, generating a power allocation parameter based on the health status and capacity status when the capacity status is greater than or equal to the preset capacity threshold, generating a power allocation parameter based on the health status when the capacity status is less than the preset capacity threshold, and adjusting the output power of the standby batteries based on a preset total power and the respective power allocation parameters of the standby batteries. A discharge management system, applicable for a plurality of standby batteries, comprises an inspection device, a computing device, and a plurality of power control devices.

### CROSS-REFERENCE TO RELATED APPLICATIONS

### Background

### 1. Technical Field

This disclosure relates to a battery management method and system, and more particularly, to a discharge management method and system.

### 2. Related Art

In a medium or large energy storage system, the primary energy storage equipment usually consists of multiple battery modules (e.g., lithium iron batteries). However, discharge management methods typically adopt a uniform load distribution approach, which fails to account for differences between the states of battery modules. This results in over-discharging of certain modules, thereby limiting the energy storage efficiency of the system and accelerating module degradation. Furthermore, variations in internal resistance, health status, and capacity among the battery modules in the system often lead to inconsistent discharge behaviors. This inconsistency becomes particularly evident at the end of discharge, where differences in voltage drop rates between modules further affect the efficiency and lifespan of the energy storage system.

### SUMMARY

Accordingly, this disclosure provides a discharge management method and system.

According to an embodiment of this disclosure, a discharge management system, applicable for a plurality of standby batteries, comprises an inspection device, a computing device and a plurality of power control devices, wherein the computing device is connected to the inspection device and the plurality of power control devices. The inspection device is configured to inspect a health status and a capacity status of each of the plurality of standby batteries. The computing device is configured to use each of the plurality of standby batteries as a target battery, determine a relationship between the capacity status and a preset capacity threshold, generate a power allocation parameter based on the health status and the capacity status when the capacity status is greater than or equal to the preset capacity threshold, and generate the power allocation parameter based on the health status when the capacity status is less than the preset capacity threshold. The plurality of power control devices is configured to adjust output power of the plurality of standby batteries based on a preset total power and the power allocation parameter of each of the plurality of standby batteries.

According to an embodiment of this disclosure, a discharge management method, applicable for a plurality of standby batteries, comprises: inspecting a health status and a capacity status of each of the plurality of standby batteries; using each of the plurality of standby batteries as a target battery, and executing: determining a relationship between the capacity status of the target battery and a preset capacity threshold, generating a power allocation parameter based on the health status and the capacity status when the capacity status is greater than or equal to the preset capacity threshold, and generating the power allocation parameter based on the health status when the capacity status is less than the preset capacity threshold; and adjusting output power of the plurality of standby batteries based on preset total power and the power allocation parameter of each of the plurality of standby batteries.

In view of the above description, the discharge management method and system of present disclosure may calculate power allocation for a plurality of standby batteries based on the status of a battery, and provide adjustment of discharge power to enhance overall system performance.

The above description of the summary of this invention and the description of the following embodiments are provided to illustrate and explain the spirit and principles of this invention, and to provide further explanation of the scope of this invention.

### BRIEF DESCRIPTION OF THE DRAWINGS

FIG. 1 is a block diagram illustrating a discharge management system according to an embodiment of the present disclosure.

FIG. 2 is a block diagram illustrating a discharge management system according to another embodiment of the present disclosure.

FIG. 3 is a flowchart illustrating a discharge management method according to an embodiment of the present disclosure.

FIG. 4 is a flowchart illustrating a handling process for abnormal battery voltage drop rates in the discharge management method according to an embodiment of the present disclosure.

FIG. 5 is a flowchart illustrating a discharge management method according to another embodiment of the present disclosure.

FIG. 6 is a flowchart illustrating monitoring of battery detection data in the discharge management method according to another embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

The discharge management device and method described below are applicable for the battery discharge management of an energy storage device and a plurality of standby batteries.

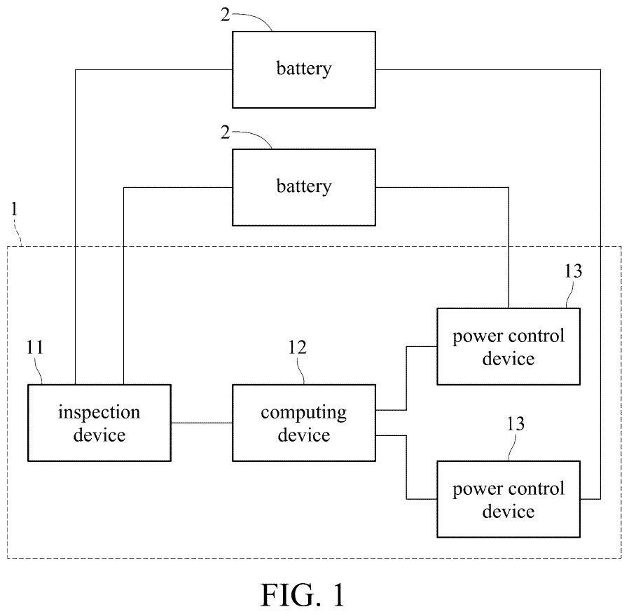

Please refer to FIG. 1, which is a block diagram illustrating a discharge management system according to an embodiment of the present disclosure. As shown in FIG. 1, the discharge management system 1 includes an inspection device 11, a computing device 12, and a plurality of power control devices 13. The computing device 12 is connected to the inspection device 11 and the plurality of power control devices 13 through wired or wireless connections. A battery 2 may be served as a standby battery, and a plurality of batteries 2 is connected with the discharge management system 1 of the present disclosure through the inspection device 11 for inspection and connected to each of the plurality of power control devices 13 for power allocation. The battery 2 may be an energy storage battery used in a storage cabinet or a traction battery used in a motorcycle, a car, and a bus. While the quantity of power control devices 13 and quantity of batteries 2 are exemplarily shown as two in FIG. 1, but the disclosure is not limited thereto, each of the quantity of power control devices 13 and the quantity of batteries 2 may be more than two. For example, the quantity of power control devices 13 may be N, connected to N batteries 2, respectively, wherein N is a positive integer greater than 1.

The inspection device 11 is configured to inspect the health status (state of health (SOH)) and capacity status of each of the plurality of standby batteries 2, wherein the capacity status may be, for example, the state of charge (SOC) or other values indicative of battery capacity. For instance, the inspection device 11 may include one or more of the following: a power meter, battery capacity tester, internal resistance tester, voltage inspection device, battery management system (BMS), battery short-circuit tester, and multi-channel battery testing system.

The computing device 12 is configured to treat each of the plurality of standby batteries 2 as a target battery, and determine the relationship between the capacity status and a preset capacity threshold. Specifically, a power allocation parameter is generated based on the health status and the capacity status when the capacity status is greater than or equal to the preset capacity threshold; the power allocation parameter is generated based on the health status when the capacity status is less than the preset capacity threshold. In an implementation, the computing device 12 may be an energy management system (EMS). In another implementation, the computing device 12 may be an embedded control system, an industrial automation controller, or a cloud server.

The plurality of power control devices 13 is configured to adjust output power of the plurality of standby batteries 2 based on preset total power and the power allocation parameter of each of the plurality of standby batteries. Each of the plurality of power control devices 13 may be a power conversion system (PCS). In an embodiment, the plurality of power control devices 13 may gather discharge of all batteries to provide total output power to a power demand device.

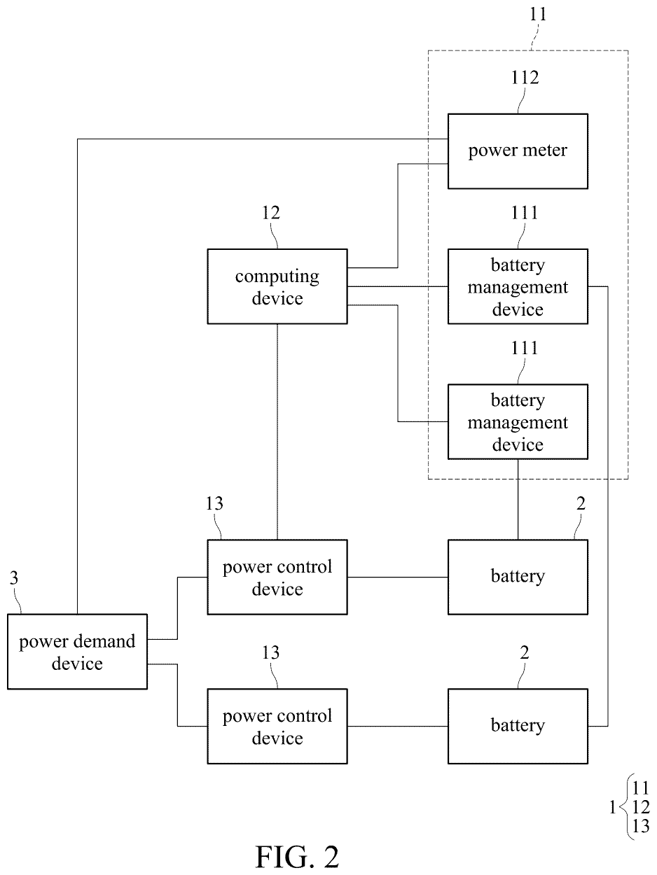

Please refer to FIG. 2, which is a block diagram illustrating a discharge management system according to another embodiment of the present disclosure. As shown in FIG. 2, the inspection device 11 of the discharge management system 1 includes a plurality of battery management devices 111 and a power meter 112. The plurality of battery management devices 111 are connected to the plurality of batteries 2, respectively, and the power meter 112 is connected to the computing device 12 and a power demand device 3, wherein the power demand device 3 is a subject being provided with power of the discharge management system 1. The implementation, functions, and connection relationships of the inspection device 11, the computing device 12, and the plurality of power control devices 13 are identical to those described in the discharge management system 1 of FIG. 1, the details are not redundantly described here. In other embodiments, the plurality of power control devices 13 may be commonly connected to a total power output line, and connected to the power demand device 3 through the total power output line.

The plurality of battery management devices 111 are configured to real-time monitor parameters such as internal resistance, health status, and charge status for each battery 2. For example, each of the plurality of battery management device 111 may be a battery management system that may conduct real-time monitoring of each battery 2, and gather data such as voltage, current, state of health (SOH), and state of charge (SOC), and these data may be transmitted to the computing device 12 to facilitate subsequent analysis and decision-making.

The power meter 112 is configured to monitor external power demand, and transmit these data to the computing device 12. For instance, the primary role of the power meter 112 may be providing accurate information of external power demand, enabling the computing device 12 to calculate the power allocation parameter for the plurality of power control devices 13 performing power adjustment, thereby making the computing device 12 to be able to optimize the operational strategy of the entire discharge management system. This ensures that the system efficiently and reliably meets the power demand of the power demand device 3. In other embodiments, the power meter 112 may be connected to the aforementioned total power output line to measure the total output power required by the power demand device 3 to serve as the preset total power.

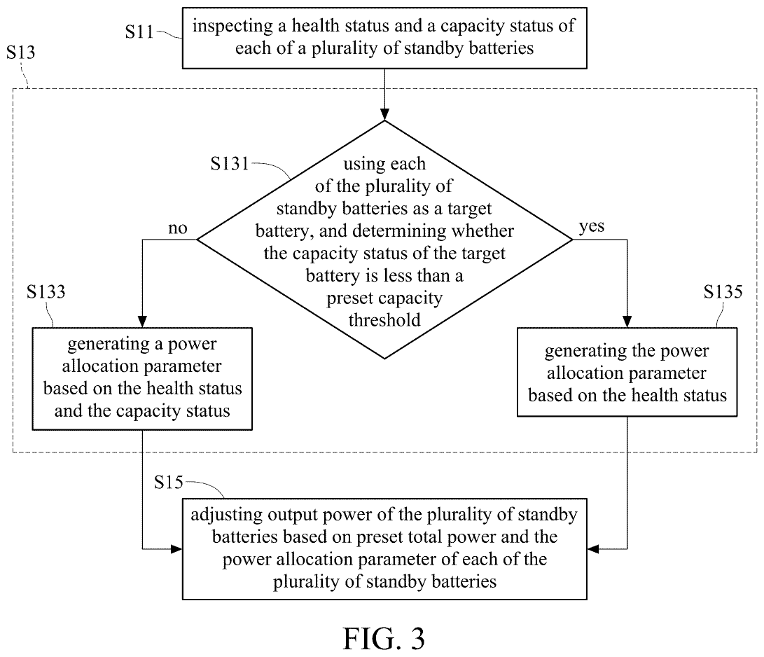

Please refer to FIG. 3, which is a flowchart illustrating a discharge management method according to an embodiment of the present disclosure. As shown in FIG. 3, the discharge management method includes step S11: inspecting a health status and a capacity status of each of the plurality of standby batteries; step S13: generating a power allocation parameter for each of the plurality of standby batteries based on the health status and capacity status of each of the plurality of standby batteries; and step S15: adjusting output power of the plurality of standby batteries based on preset total power and the power allocation parameter of each of the plurality of standby batteries. Step S13 includes step S131: using each of the plurality of standby batteries as a target battery, and determining whether the capacity status of the target battery is less than a preset capacity threshold; when the determination in step S131 is “no”, indicating that the capacity status of the target battery is greater than or equal to the preset capacity threshold, executing step S133: generating a power allocation parameter based on the health status and the capacity status; and when the determination in step S131 is “yes,” indicating that the capacity status of the target battery is less than the preset capacity threshold, executing step S135: generating a power allocation parameter based on the health status. The discharge management method may be applicable for the discharge management system 1 shown in FIGS. 1 and 2, and the following description exemplifies the application using the discharge management system 1 shown in FIG. 1 to explain the discharge management method in FIG. 3.

In step S11, the inspection device 11 inspects the health status and the capacity status of each of the plurality of batteries 2. Specifically, the inspection device 11 may simultaneously inspect the capacity status of the plurality of batteries 2, then subsequently inspect the health status of the plurality of batteries 2, or simultaneously detect both the capacity status and health status of each battery 2, but this disclosure is not limited thereto.

In an embodiment, the inspection device 11 may include a plurality of battery management devices 111 and a power meter 112, and may use the plurality of battery management devices 111 to inspect the plurality of batteries 2, respectively.

In step S131, the computing device 12 receives the health status and the capacity status of each of the plurality of batteries 2 from the inspection device 11, and uses each of the plurality of batteries 2 as a target battery to determine whether the capacity status of the target battery is less than a preset capacity threshold. For example, the preset capacity threshold may be 25%. In other embodiments, step S131 may also be replaced by: using each of the plurality of standby batteries as a target battery, and determining whether the capacity status of the target battery is greater than or equal to the preset capacity threshold.

In step S133, the computing device 12 generates a power allocation parameter according to the health status and the capacity status when the capacity status of the target battery is greater than or equal to the preset capacity threshold. Please refer to Formula (1), which may be the calculation formula used by the computing device 12 to generate the power allocation parameter according to the health status and the capacity status, wherein SOHᵢ is the health status of the target battery, SOC; is the capacity status of the target battery, SOHⱼ is the health status of j-th battery, SOC; is the capacity status of j-th battery, wᵢ is the power allocation parameter of the target battery, and N is a quantity of the plurality of standby batteries. The computing device 12 may acquire the power allocation parameter wᵢ calculated by using the capacity status SOCᵢ and the health status SOHᵢ of the target battery, and the capacity status SOCⱼ and the health status SOH; of other standby batteries when the capacity status SOCᵢ of the target battery is greater than or equal to the preset capacity threshold.

$${w}_{i} = \frac{{SOH}_{i} \times {SOC}_{i}}{{\sum }_{j = 1}^{N} {SOH}_{j} \times {SOC}_{j}} ; \qquad Formula ( 1 )$$

In step S135, the computing device 12 generates a power allocation parameter according to the health status when the capacity status of the target battery is less than the preset capacity threshold. Please refer to Formula (2), which may be the calculation formula used by the computing device 12 to generate the power allocation parameter according to the health status of the target battery, wherein SOHᵢ is the health status of the target battery, SOHⱼ is the health status of the j-th battery, wᵢ is the power allocation parameter of the target battery, N is the quantity of the plurality of standby batteries, α is greater than 1, and a may be a control parameter configured to enhance the effect of reducing the burden of a battery with poor health status. The computing device 12 may calculate the health status SOHᵢ of the target battery and the health status SOHⱼ of other standby batteries to acquire the power allocation parameter wᵢ when the capacity status of the target battery is less than the preset capacity threshold.

$${w}_{i} = \frac{{SOH}_{i}^{α}}{{\sum }_{j = 1}^{N} {SOH}_{j}^{α}} ; \qquad Formula ( 2 )$$

In an embodiment, the control parameter a is equal to 2, but this disclosure is not limited to the value, and the control parameter a may be adjusted based on an actual condition.

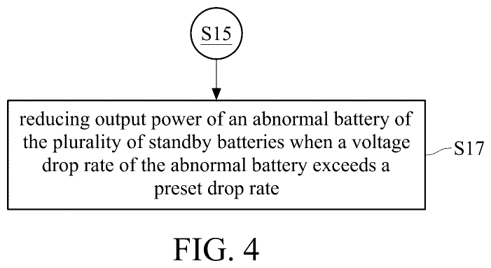

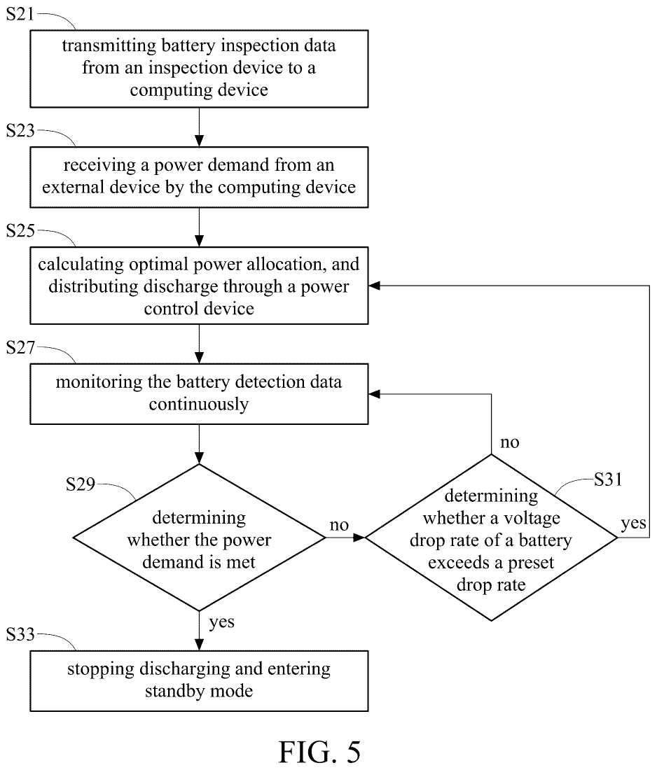

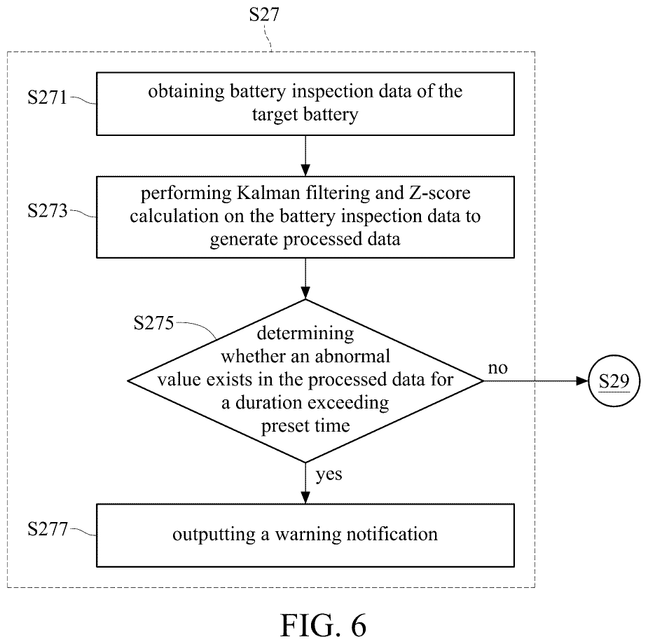

In step S15, the plurality of power control devices 13 adjust output power of the plurality of standby batteries 2 based on preset total power (for example, the total output power required by the power demand device 3 shown in FIG. 2) and the power allocation parameter of each of the plurality of standby batteries 2. For instance, the preset total power may be obtained by a power meter (such as power meter 112 shown in FIG. 2), and the output power of the plurality of standby batteries 2 may be, for example, the preset total power multiplied by the power allocation parameter of each of the plurality of standby battery 2, respectively. To further explain step S15, please refer to FIGS. 4, 5, and 6 together. FIG. 4 is a flowchart illustrating a handling process for abnormal battery voltage drop rates in the discharge management method according to an embodiment of the present disclosure, FIG. 5 is a flowchart illustrating a discharge management method according to another embodiment of the present disclosure, and FIG. 6 is a flowchart illustrating monitoring of battery detection data in the discharge management method according to another embodiment of the present disclosure.

In an embodiment shown in FIG. 4, the discharge management method includes steps S11˜S15 shown in FIG. 3 and step S17: reducing output power of an abnormal battery of the plurality of standby batteries when a voltage drop rate of the abnormal battery exceeds a preset drop rate, which is executed after step S15.

In step S17, when the voltage drop rate of one of the plurality of standby batteries 2 exceeds the preset drop rate and is identified as an abnormal battery, the power control device 13 reduces the output power of the abnormal battery. For example, the power control device 13 may use an adjustment coefficient β to reduce the output power of the abnormal battery when the voltage drop rate exceeds the preset drop rate. Specifically, the adjustment coefficient β may range from 0 to 1, such as 0.5, but it may be adjusted based on an actual condition. In an embodiment, battery 2 may undergo discharge rate tests from 0.1C to 1.0C, with each 0.1C serving as a step for discharge rate statistics, and the mean value of the statistical result plus or minus three standard deviations is eventually defined as the preset drop rate. In an embodiment, the discharge rate statistics may involve conducting a plurality of rate tests or repeated rate tests on battery 2 and using the average as a golden sample. In an embodiment, temperature may be included as a consideration parameter of discharge rate tests.

In an embodiment, a power difference is between the output power of the abnormal battery before the reducing and the output power of the abnormal battery after the reducing, and the power control device 13 distributes the power difference to the remaining batteries other than the abnormal battery among the plurality of standby batteries 2 according to the power allocation parameter of each of the plurality of standby batteries 2. For example, in a battery module with four batteries, total power is 1 megawatt (MW), the output power of the four batteries is 247 kilowatts (kW), 277 kW, 168 kW, and 308 kW, respectively. When the voltage drop rate of the 168 kW battery exceeds the preset drop rate and is identified as an abnormal battery, an adjustment coefficient β of 0.5 is applied for calculating reduced output power of 84 kW for the battery, and a power difference is 84 kW. The power difference is then distributed to the remaining batteries. Assuming the power allocation parameters of each of the remaining batteries are 0.239, 0.270, and 0.321, the distributed power for the remaining batteries may be calculated, that is, approximately 271 kW, 304 kW, and 341 kW are distributed to the remaining batteries, respectively.

As shown in FIG. 5, the discharge management method includes step S21: transmitting battery inspection data from an inspection device to a computing device; step S23: receiving a power demand from an external device by the computing device; step S25: calculating optimal power allocation, and distributing discharge through a power control device; step S27: monitoring the battery detection data continuously; step S29: determining whether the power demand is met; when determination in step S29 is “no,” executing step S31: determining whether a voltage drop rate of a battery exceeds a preset drop rate; when determination in step S29 is “yes,” executing to step S33: stopping discharging and entering standby mode; when determination in step S31 is “yes,” executing back to step S25; and when determination in step S31 is “no,” executing back to step S27.

As shown in FIG. 6, step S27 in FIG. 5 may include step S271: obtaining battery inspection data of the target battery; step S273: performing Kalman filtering and Z-score calculation on the battery inspection data to generate processed data; step S275: determining whether an abnormal value exists in the processed data for a duration exceeding preset time; and step S277, outputting a warning notification. In step S271, the computing device 12 obtains the battery inspection data of the target battery from the inspection device 11. In step S273, the computing device 12 performs Kalman filtering and Z-score calculation on the battery inspection data to generate processed data. In step S275, the computing device 12 determines whether the duration of the abnormal value presenting in the processed data exceeds the preset time. In step S277, the computing device 12 outputs the warning notification. For example, the computing device 12 may remove noise through Kalman filtering. When Z-score detected is more than five times of the standard deviation, an abnormal value is considered to exist. The content of the abnormal value may include a parameter such as voltage, temperature, SOC, SOH, and internal resistance, etc., and the duration of the abnormal value existing lasts for a period of about 5-20 seconds or more. The warning notification may be an alarm voltage data abnormality, temperature data abnormality, etc., and may hand over to the computing device 12 for processing according to the degree of harm of the abnormality. The most serious said processing performed by the computing device 12 is immediate shutdown. Specifically, the abnormal value is categorized based on different data objects and classified using different multipliers, and the majority is a value exceeding more than five times.

In view of the above description, the discharge management method and system of present disclosure may calculate power allocation for a plurality of standby batteries based on the status of a battery, and provide adjustment of discharge power to enhance overall system performance. Additionally, by monitoring the voltage drop rate of the standby batteries using the power monitoring device, the discharge management method and system of present disclosure may prevent individual battery from over-discharging or under-discharging, ensuring the stability and safety of the overall system.

What is claimed is:

1. A discharge management method, applicable for a plurality of standby batteries, comprising:
inspecting a health status and a capacity status of each of the plurality of standby batteries;
using each of the plurality of standby batteries as a target battery, and executing:
determining a relationship between the capacity status of the target battery and a preset capacity threshold;
generating a power allocation parameter based on the health status and the capacity status when the capacity status is greater than or equal to the preset capacity threshold; and
generating the power allocation parameter based on the health status when the capacity status is less than the preset capacity threshold; and
adjusting output power of the plurality of standby batteries based on preset total power and the power allocation parameter of each of the plurality of standby batteries.

2. The discharge management method according to claim 1, wherein the preset capacity threshold is 25%.

3. The discharge management method according to claim 1, further comprising:
obtaining battery inspection data of the target battery;
performing Kalman filtering and Z-score calculation on the battery inspection data to generate processed data; and
outputting a warning notification when an abnormal value exists in the processed data for a duration exceeding preset time.

4. The discharge management method according to claim 1, further comprising:
reducing output power of an abnormal battery of the plurality of standby batteries when a voltage drop rate of the abnormal battery exceeds a preset drop rate.

5. The discharge management method according to claim 4, wherein a power difference is between the output power of the abnormal battery before the reducing and the output power of the abnormal battery after the reducing, and the discharge management method further comprises: distributing the power difference to remaining batteries other than the abnormal battery among the plurality of standby batteries according to the power allocation parameter of each of the plurality of standby batteries.

6. The discharge management method according to claim 1, wherein
generating the power allocation parameter based on the health status and the capacity status comprises: using a calculation formula to generate the power allocation parameter, and the calculation formula including:
$${w}_{i} = \frac{{SOH}_{i} \times {SOC}_{i}}{{\sum }_{j = 1}^{N} {SOH}_{j} \times {SOC}_{j}} ;$$
wherein SOH_i is the health status, SOC_i is the capacity status, SOH_j is a health status of a j-th battery, SOC_j is a capacity status of the j-th battery, w_i is the power allocation parameter, and N is a quantity of the plurality of standby batteries.

7. The discharge management method according to claim 1, wherein generating the power allocation parameter based on the health status comprises: using a calculation formula to generate the power allocation parameter, and the calculation formula including:
$${w}_{i} = \frac{{SOH}_{i}^{α}}{{\sum }_{j = 1}^{N} {SOH}_{j}^{α}} ;$$
wherein SOH_i is the health status, SOH_j is a health status of a j-th battery, w_i is the power allocation parameter, α is greater than 1, and N is a quantity of the plurality of standby batteries.

8. The discharge management method according to claim 7, wherein α is equal to 2.

9. A discharge management system, applicable for a plurality of standby batteries, comprising:
an inspection device configured to inspect a health status and a capacity status of each of the plurality of standby batteries;
a computing device connected to the inspection device, configured to use each of the plurality of standby batteries as a target battery, determine a relationship between the capacity status and a preset capacity threshold, generate a power allocation parameter based on the health status and the capacity status when the capacity status is greater than or equal to the preset capacity threshold, and generate the power allocation parameter based on the health status when the capacity status is less than the preset capacity threshold; and
a plurality of power control devices connected to the computing device, configured to adjust output power of the plurality of standby batteries based on a preset total power and the power allocation.
